(19) United States
(12) Patent Application Publication
(10) Pub. No.: US 2019/0087712 A1
(43) Pub. Date: Mar. 21, 2019

(54) Neural Network Co-Processing

(71) Applicant: QUALCOMM Incorporated, San Diego, CA (US)

(72) Inventors: Sairam Sundaresan, San Diego, CA (US); Bijan Forutanpour, San Diego, CA (US); Pravin Kumar Ramadas, San Diego, CA (US)

(21) Appl. No.: 15/707,409

(22) Filed: Sep. 18, 2017

(51) Int. Cl. G06N 3/04; G06N 3/08

(52) U.S. Cl. CPC G06N 3/0454; G06N 3/08

(57) ABSTRACT

A neural network processing system be configured to: (a) execute a first neural network and a second neural network; (b) run a first data segment through the first neural network to return a first score and run a second data segment through the second neural network to return a second score; (c) compare the first score with the second score; and (d) retrain the first neural network based on the comparison

### CROSS-REFERENCE TO RELATED APPLICATIONS

None.

### STATEMENT ON FEDERALLY SPONSORED RESEARCH OR DEVELOPMENT

None.

### BACKGROUND

### Field of the Disclosure

This disclosure relates to neural networks.

### Description of Related Art

Neural networks can be configured to classify incoming data. Neural networks often include a plurality of different neurons. Each neuron typically accepts multiple inputs, combines the inputs according to a formula (e.g., a model), and then outputs the formula's result.

Each neuron's formula can be adjusted (e.g., by updating coefficients) to improve the quality of the neural network's analysis. This adjustment process is called training. During supervised training, a user feeds an input (e.g., an image) into a neural network and compares the neural network's output (also called the observed output) to a correct output.

When the observed output and the correct output differ, the neural network can automatically adjust (i.e., retrain) such that in the future, the same input produces the correct output. The adjustment can include updating the coefficients.

### SUMMARY

Disclosed is a neural network processing system. The neural network processing system can include one or more processors. The one or more processors can be configured to: (a) execute a first neural network and a second neural network; (b) run a first data segment through the first neural network to return a first score and run a second data segment through the second neural network to return a second score; (c) compare the first score with the second score; and (d) retrain the first neural network based on the comparison.

Disclosed is a method of processing data with a neural network. The method can include executing a first neural network and returning a first score by running a first data segment through the first neural network; executing a second neural network and returning a second score by running a second data segment through the second neural network.

The method can include comparing the first score with the second score, determining whether to retrain the first neural network based on the comparison, determining whether to retrain the second neural network based on the comparison, and retraining the first neural network based on the second score or retraining the second neural network based on the first score.

Disclosed is a neural network processing system. The processing system can include: (a) means for producing a first score from a first data segment with a first neural network; (b) means for producing a second score from a second data segment with a second neural network; (c) means for comparing the first score with the second score; and (d) means for retraining the first neural network based on the second score.

Disclosed is a non-transitory, computer-readable storage medium. The medium can include program code. The program code, when executed by one or more processors, can cause the one or more processors to: (a) extract a first data segment from a first feed and extract a second data segment from a second feed; (b) analyze the second data segment; (c) crop the first data segment based on the analysis.

The program code, when executed by one or more processors, can cause the one or more processors to: (e) execute a first neural network and a second neural network; (f) run the cropped first data segment through the first neural network to produce a first score; and (g) run the second data segment through the second neural network to produce a second score.

### BRIEF DESCRIPTION OF DRAWINGS

For clarity and ease of reading, some Figures omit views of certain features. The Figures are not drawn to scale.

FIG. 1 is a block diagram of an example neural network system.

FIG. 1A is a block diagram of an example application of the neural network system.

FIG. 1B shows that the example neural network system can include more than two neural networks.

FIG. 2 is a block diagram of an example method of applying the neural network system of FIG. 1.

FIG. 3 is a schematic of an example neural network.

FIG. 3A is a schematic of an example neuron of the neural network.

FIG. 4 is a block diagram showing example modifications to the neural network system.

FIG. 4A is a block diagram showing example modifications to the neural network system.

FIG. 5 is a schematic of an example source localization technique.

FIG. 6 is a block diagram of an example method of applying the neural network system of FIG. 1.

FIG. 7 is a block diagram of an example processing system.

### DETAILED DESCRIPTION

### Part 1

The claimed inventions can be embodied in many forms. Some examples are shown in the drawings and described below. Because the examples are only illustrative, the claimed inventions are not limited to the examples. Implementations of the claimed inventions can include different features than in the examples.

Furthermore, changes and modifications can be made to the claimed inventions without departing from their spirit. The claimed inventions are intended cover such changes and modifications.

### Part 2

According to the present disclosure, multiple neural networks can analyze related data feeds to produce a score (i.e., an output). For example, a video feed can include images and audio. The video feed can be split into an image feed and an audio feed. One neural network can analyze the image feed to produce an image score. Another neural network can analyze the audio feed to produce an audio score.

Each neural network can be configured (also called trained) to identify real-world objects presented within a feed. For example, the image neural network can identify when the image feed includes images of a dog or a cat and the audio neural network can be configured to identify when the audio feed includes audio of a dog or a cat. Therefore, if the video feed included a barking dog, then both the image and audio neural networks should output a score proposing “dog.”

Perfectly training neural networks is difficult. For example, it may be easy for an image neural network to distinguish between images of a cat and a dog, but it may be difficult for the image neural network to distinguish between images of a dog and a wolf or a cat and a fox.

Examples of the disclosed neural network system use two or more neural networks to confirm observations. For example, if the image neural network is 40% confident that video feed includes images of a dog, but the audio neural network is 90% confident that audio feed includes sounds from a dog, then the system can be more than 90% confident that the video feed presents a dog.

Furthermore, scores from one neural network can be used to retrain (i.e., improve) another neural network. For example, due to the high confidence of the audio neural network, the system can automatically retrain (i.e., reconfigure) the image neural network to propose “dog” with greater confidence when analyzing similar images in the future.

### Part 3

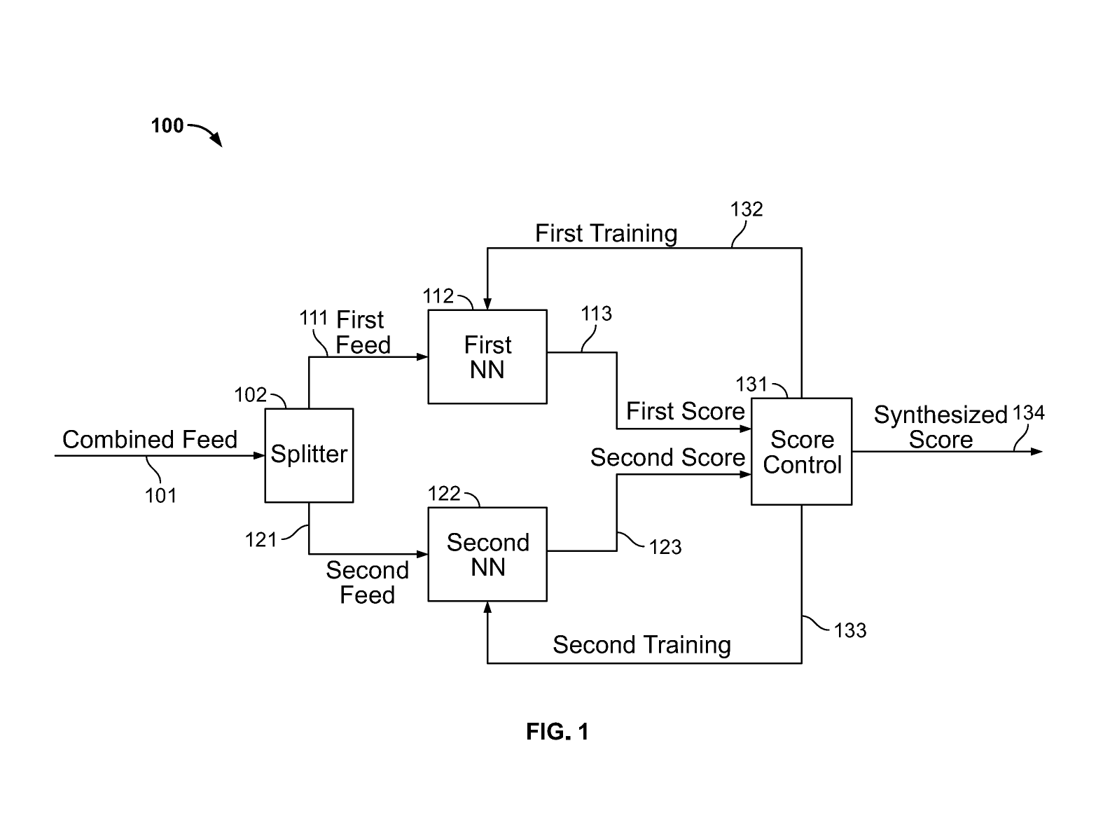

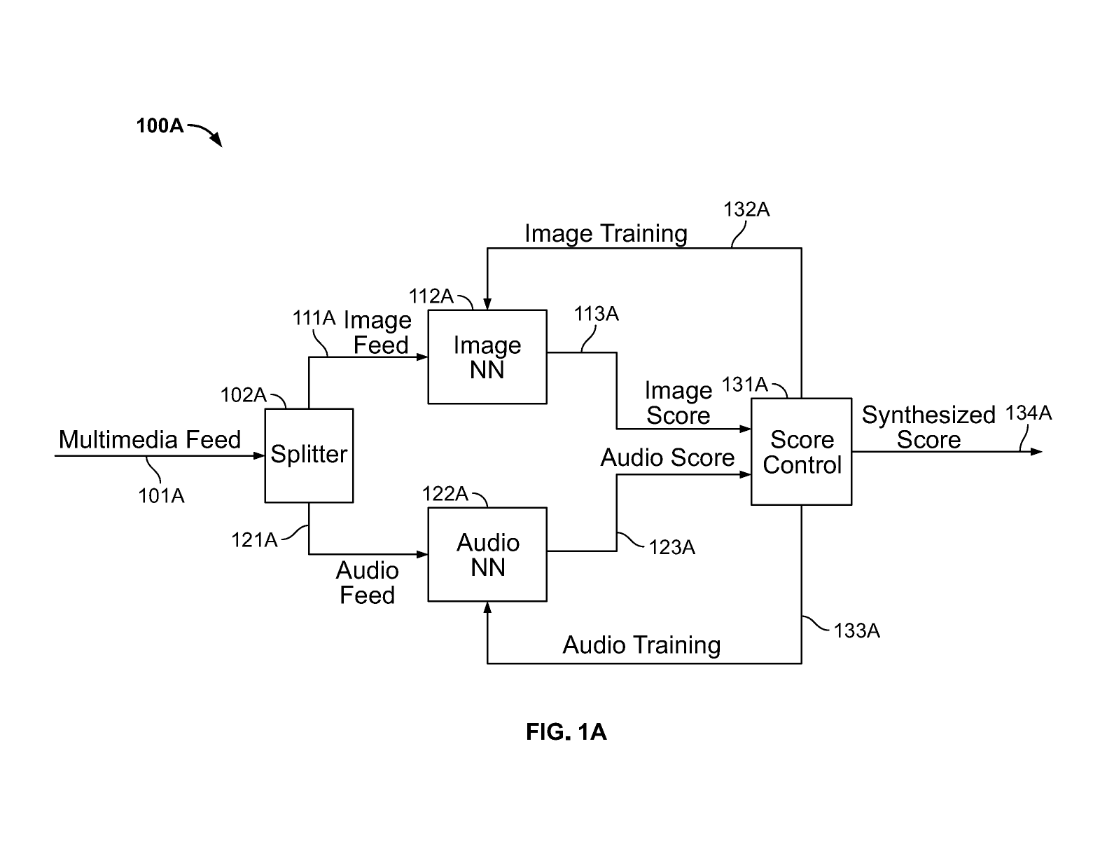

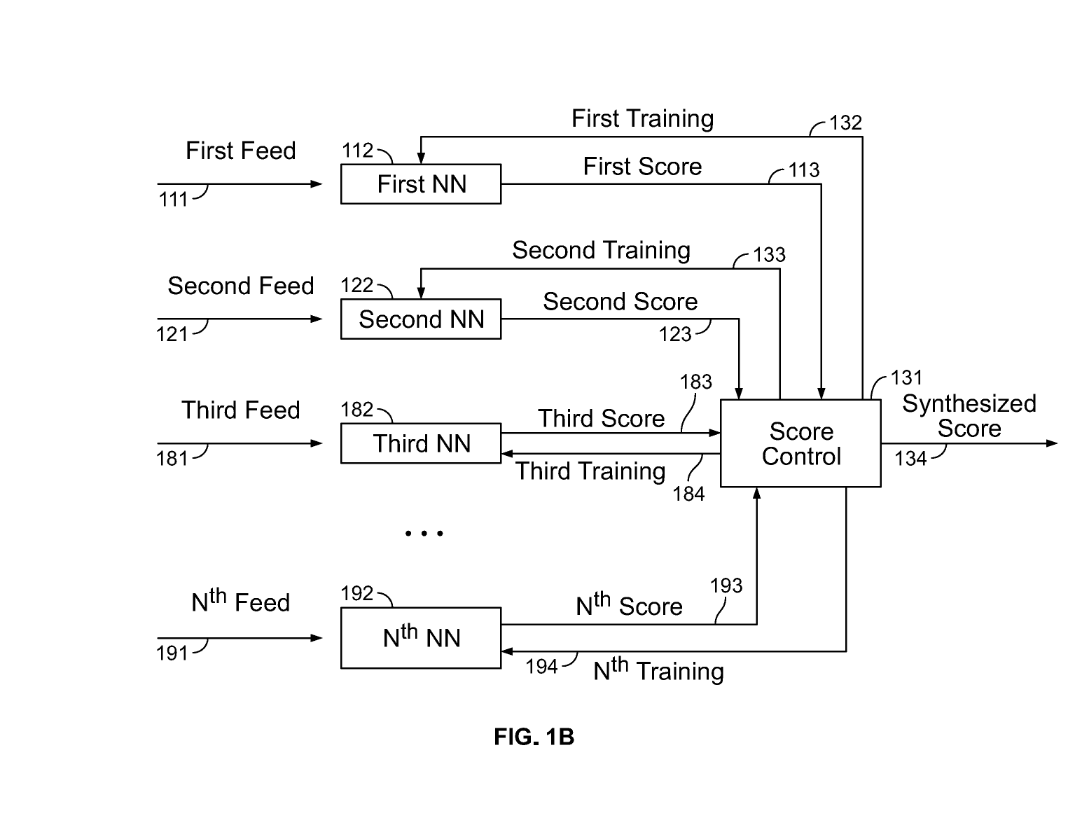

Referring to FIGS. 1, 1A, and 1B, neutral network (“NN”) system 100 can include a first NN 112, a second NN 122, a third NN 182, . . . an Nth NN 192. Among other things, the present disclosure enables NN system 100 to conduct unsupervised training on NNs 112, 122, 182, 192.

Each NN can output a score 113, 123, 183, 193 in response to a data feed. Each score 113, 123, 183, 193 can represent an independent analysis of the feed. For example, each score 113, 123, 183, 193 can estimate the probability that a video feed presents a certain object (e.g., a cat, a dog, a mouse).

If the scores 113, 123, 183, 193 are different, then processing system 100 can judge which score(s) are more accurate and which score(s) are less accurate. NN system 100 can apply the more accurate score(s) to retrain the NN(s) that produced the less accurate score(s).

For example, first score 113 can propose, with high confidence, that the video feed presents a dog. Second score 123 can propose, with low confidence, that the video feed presents a horse. Due to the disparities in confidence, NN system 100 can assume that first score 113 is more accurate and second score 123 is less accurate. NN system 100 can retrain second NN 122 to propose dog in response to the feed.

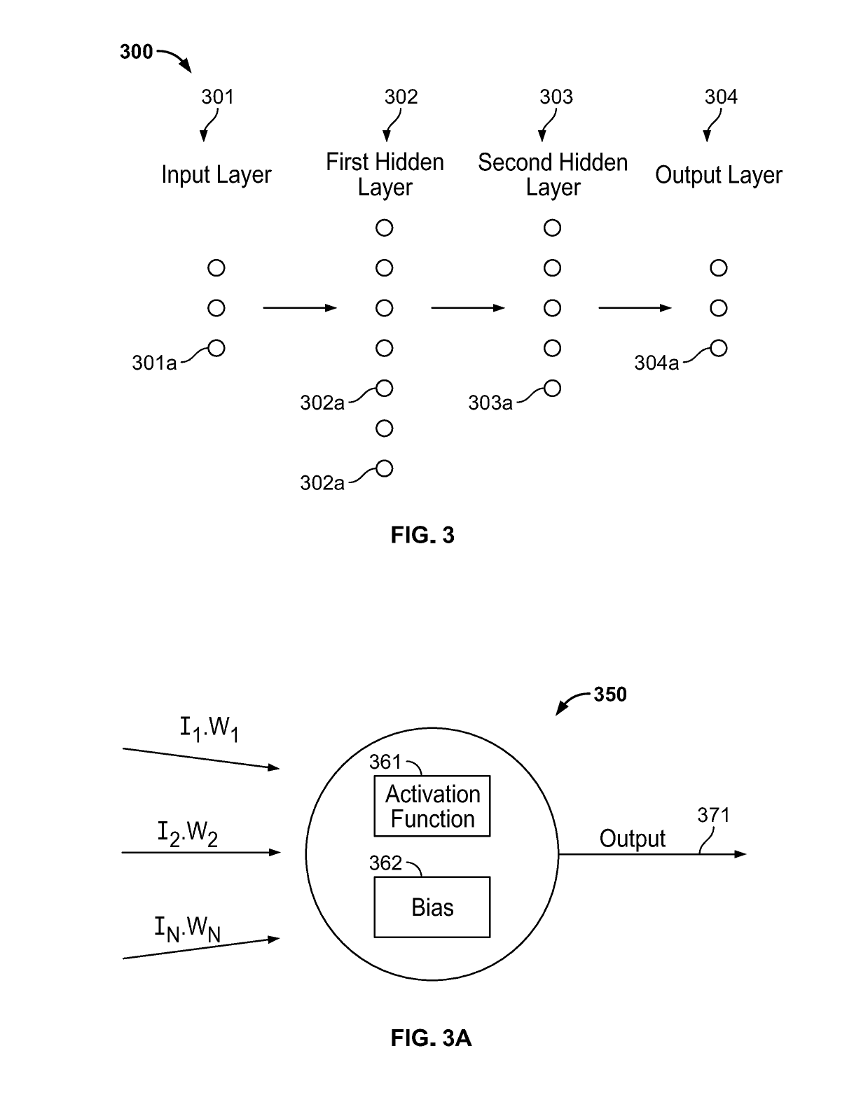

Therefore, examples of NN system 100 enable learning across different NNs 112, 122, 182, 192. Cross-learning can be advantageous if a user has a well-trained NN and a untrained NN. As discussed below with reference to FIG. 3, supervised training often relies on a preassembled training set of known inputs matched with desired outputs. A training set may be impractical to assemble.

Assume that second NN 122 is well-trained and first NN 112 is untrained. A user can configure NN system 100 to perform unsupervised training on first NN 112.

The user can pair the first NN 112 with second NN 122. As the second NN 112 analyzes incoming real-world data, NN system 100 can apply the analysis to train first NN 112. Once first NN 112 is trained, the user can set NN system 100 to enable cross-unsupervised training, where both NNs 112, 122 can learn from each other.

Returning to FIGS. 1, 1A, and 1B, each block of NN system 100 can represent (a) a discrete piece of hardware in a processing system or (b) a task (e.g., software function) performed by a processing system. According to some examples, the processing system (e.g., processing system 700 of FIG. 7) can run NN system 100 on a single processor. Processing system 700 is discussed below with reference to FIG. 7.

System 100 can include multiple NNs 112, 122, 182, 192. Each NN can be configured to score (e.g., classify) a different type (also called modality) of incoming data. FIG. 1A shows image-audio NN system 100A, which is an example application of NN system 100.

Referring to FIGS. 1 and 1A combined feed 101 can be a multimedia feed 101A such as video output from a camera encoded according to any suitable format such as H.264, AVI, MP4, and the like. Splitter 102, 102A can break (e.g., separate, divide, or split) multimedia feed 101 into a first feed 111 (e.g., image feed 111A) and a second feed (e.g., audio feed 121A). Image feed 111A can contain a series of frames (e.g., digital images). Audio feed 121A can include digital samples of a sound wave.

Multimedia feed 101A, image feed 111A, and second feed 121A can all be data streams such as streaming video, streaming images, and streaming audio. Combined feed 101 and multimedia feed 101A do not need to be streams. Combined feed 101 and multimedia feed 101A can consist of non-video and non-audio feeds captured with any sensors disclosed herein (e.g., LiDAR sensors, temperature sensors, speed sensors, and the like).

Splitter 102 can send first feed 111 to first NN 112 (e.g., image NN 112A) and second feed 121 to second NN 122 (e.g., audio NN 122A). As with all features disclosed herein, the presence of combined feed 101 and splitter 102 is optional. First and second feeds 111, 121 can be downsampled (e.g., via splitter 102). System 100 can directly accept first and second feeds 111, 121 if, for example, first and second feeds 111, 121 were independently delivered to system 100.

Before being linked in NN system 100, both first NN 112 and second NN 122 can be initialized. Put differently, first NN 112 can be pre-configured (e.g., pre-trained) to score first feed 111 and second NN 122 can be pre-configured to score second feed 121.

Alternatively, only one NN can be trained and the other NN can be untrained. NN system 100 can initially configured to only enable one-way learning such that the trained NN can train the untrained NN, but the untrained NN cannot train the trained NN. Once both NNs are trained, NN system 100 can be subsequently configured to enable cross-training.

First NN 112 can return a first score 113 (e.g., image score 113A) and second NN 122 can return a second score 123 (e.g., audio score 123A). Deep NN 300 (see FIG. 3 below) can be representative of first/image NN 112/112A, second/audio NN 122/122A, third NN 182, and/or fourth NN 192.

Scores 113, 123 can include one or more classification matrices. When the present disclosure refers to matrices, such matrices can be vectors (e.g., a matrix with a single column and/or a single row). A classification matrix can be an index of confidences, such as values representing probabilities. Each entry in the matrix can represent the NN's confidence in a certain outcome.

Through scores 113, 123, first and second NNs 112, 122 can classify their respective feeds 111, 121 based on predetermined object sets. For example, image NN 112A and audio NN 122A can each have an object set of: [dog, cat, horse]. According to this example, image score 113A would convey: [probability that image feed 111A depicts a dog, probability that image feed 111A depicts a cat, and probability that image feed 111A depicts a horse]. An image score 113A of [0.5, 0.3, 0.2] would mean that image NN 112A found a 50% chance of image feed 111A depicting a dog, a 30% chance of image feed 111A depicting a cat, and a 20% chance of image feed 111A depicting a horse.

An object set can include thousands of different objects. As discussed below, first NN 112 and second NN 122 can have different but overlapping object sets. First score 113 can be a matrix (e.g., a multi-dimensional vector) listing the confidence of each object in the first object set. Second score 123 can be a matrix listing the confidence of each object in the second object set. The term “object”, as used herein, does not necessarily mean “physical object”. For example, an “object” can represent one or more properties of a physical object such as velocity and/or acceleration.

Score control 131, 131A can analyze first and second scores 113, 123 (e.g., compare the image and audio classification matrices). Score control 131 can produce one or more of: (a) first training 132 (e.g., image training 132A) (b) second training 133 (e.g., audio training 133A), and (c) synthesized score 134 (e.g., image-audio synthesized score 134A).

First training 132 can cause first NN 112 to retrain. Second training 133 can cause second NN 122 to retrain. Retraining is discussed in greater detail below, but can include readjusting one or more weights and biases of a NN to reduce a cost C output by a cost function CF. Retraining can include adjusting any property of a NN to improve the NN's performance.

Synthesized score 134 can represent a final classification of NN system 100 with respect a segment of combined feed 101. After score control 131 produces synthesized score 134, along with any training 132, 133, system 100 can analyze a new segment of combined feed 101.

Referring to FIG. 1B, system 100 can any number of NNs (e.g., ten). Third NN 182 can analyze a third feed 181 (which can be supplied by splitter 102) to produce a third score 183 and an Nth NN 192 (according to example, “N” would be ten) can analyze an Nth feed 191 (which can be supplied by splitter 102) to produce an Nth score 194. Third training 184 can cause third NN 182 to retrain. Nth training 194 can cause Nth NN 192 to retrain. Consistent with FIG. 1B, any NN system 100 discussed herein can include any number of NNs.

Score control 131 can produce synthesized score 134 based on each incoming score 113, 123, 183, 193. Score control 131 can retrain any or all of the NNs 112, 122, 182, 192 based on analysis of each incoming score 113, 123, 183, 193. According to one example, system 100 includes three NNs (e.g., image NN 112A, audio NN 122A, and a LiDAR NN).

### Part 4

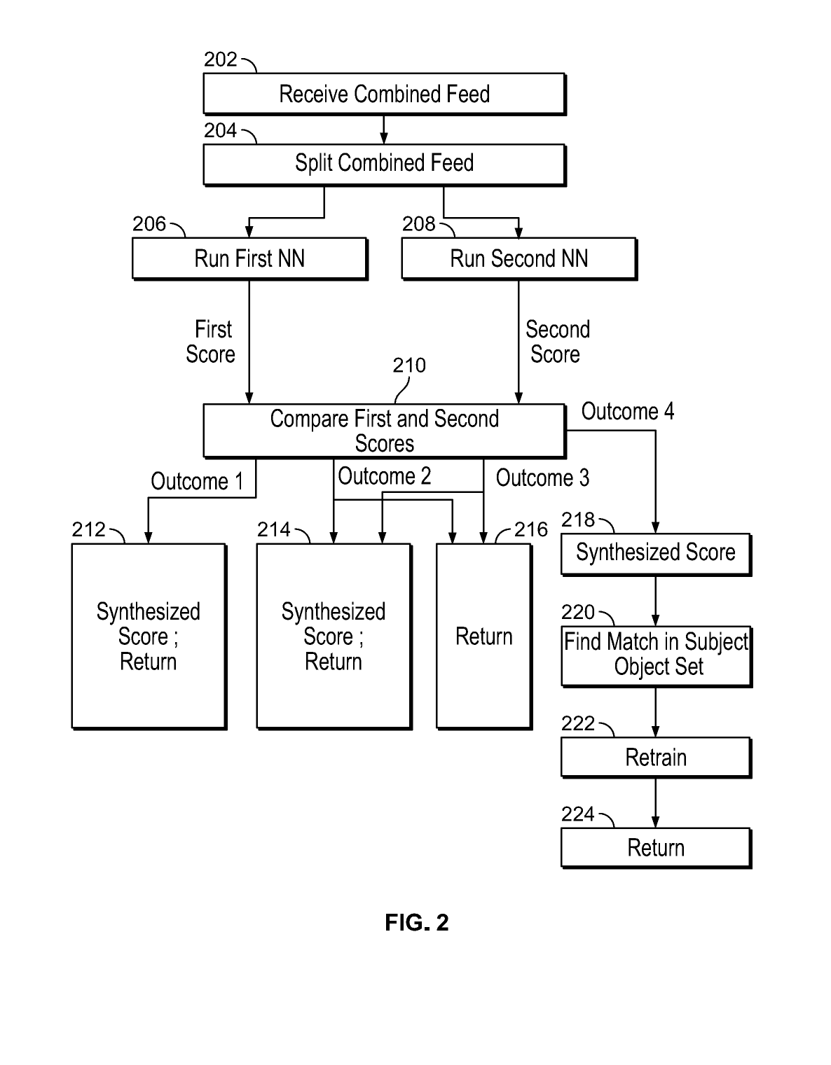

FIG. 2 is a block diagram of operations (e.g., a method) consistent with the present disclosure. Processing system 700 (see FIG. 7) can perform and be configured to perform any and all of these operations. To perform at least some of these operations, processing system 700 can execute system 100 as code. Processing system 700 can perform the operations of FIG. 2 to (a) retrain one or both of image NN 112 and audio NN 122 and (b) return a synthesized score 134 (e.g., a classification matrix).

Synthesized score 134 can be useful in a range of contexts. For example: (a) An autonomous vehicle can automatically apply synthesized score 134 to classify upcoming objects as pedestrians, animals, or trash. The vehicle can determine whether to automatically brake and/or reduce motor speed based on synthesized score 134. (b) A manufacturing facility can rely on synthesized score 134 to identify trespassers (as opposed to wildlife); (c) A government can collect and analyze synthesized scores 134 to estimate the number of people who cross an intersection.

Synthesized score 134 can include some or all of the following features: [first proposal, confidence of first proposal, time associated with the analyzed segment of first feed; second proposal, confidence of second proposal, time associated with the analyzed segment of second feed; outcome number].

For example, the synthesized score 134 could include: [bird, 80% confidence, 8:58:00 am-8:58:10 am; mouse, 20% confidence, 8:58:00 am-8:58:10 am; etc.]. This synthesized score 134 would convey that NN system 100 was 80% confident that combined feed 101 presented a bird between 8:58:00 am-8:58:10 am and was 20% confident that combined feed 101 presented a mouse during the same time interval. According to some examples, the sum of all confidences in synthesized score 134 must be less than or equal to 100%. According to other examples, the sum of all confidences in synthesized score 134 can be greater than 100%.

At block 202, processing system 700 can accept combined feed 101 from any sensor or combination thereof disclosed herein. At block 204, processing system 700 can apply splitter 102 to separate combined feed 101 into first feed 111 and second feed 121. Each feed 111, 121 can have a different modality. At block 206, processing system 700 can run a segment of first feed 111 through first NN 112. At block 208, processing system 700 can run a segment of second feed 121 through second NN 122.

At block 210, processing system 700 can analyze (e.g., compare) first score 113 with second score 123. To conduct the comparison, processing system 700 can assess whether each incoming score 113, 123 includes a well-separated proposal (e.g., whether a specific object in the classification matrix has a high confidence compared with the rest of the objects in the object set).

A proposal can be the highest-confidence object in a particular score. Proposal separation can be determined according to any suitable algorithm. For example, a well-separated proposal may occur when the highest-confidence object in a score has at least a predetermined multiple of (e.g., twice) the confidence of the next highest confidence object in the score.

Processing system 700 can thus mark each incoming score as (a) including a well-separated proposal or (b) not including a well-separated proposal. Based on these marks, the comparison can result in at least four different outcomes. Outcome 1: well-separated matching proposals exist. Outcome 2: no well-separated proposals exist. Outcome 3: well-separated non-matching proposals exist. Outcome 4: one well-separated proposal exists, but the other proposal is not well separated.

First Score 113

| | | No well- |
|---|---|---|
| | Well-separated | separated |
| Comparison Result | proposal | proposal |

| | | | |
|---|---|---|---|
| Second | Well- | If matching well- | Outcome 4 |
| Score | separated | separated proposals, | |
| 123 | proposal | then Outcome 1; | |
| | | otherwise, Outcome 3 | |
| | No well- | Outcome 4 | Outcome 2 |
| | separated | | |
| | proposal | | |

As shown in the above table, the comparison result can depend on whether the first proposal matches the second proposal. Equivalent (i.e., identical) proposals match. Consistent proposals can also match.

For example, if the first proposal was “cat” and the second proposal was “animal”, then the first and second proposals would be consistent. As further discussed below, processing system 700 can store and apply a score linking map, which relates (a) identical objects across object sets with two-way links and (b) non-identical, but consistent proposals with two-way links and/or one-way links.

For consistent objects, the score linking map can store one-way links to indicate a species/genus relationship. For example, “animal” is generic to “cat”, but “cat” is not generic to “animal”. Thus, a link between “animal” and “cat” could be a one-way link going from “cat” to “animal”, but not “animal” to “cat”. The benefit of one-way links is discussed below.

Practical examples of the outcomes appear below. For convenience, the examples assume that combined feed 101 is a video feed 101A, first NN 112 is an image NN 112A, and second NN is an audio NN 122A. In these examples, “high confidence” means a proposal is well-separated and “low confidence” means a proposal is not well-separated.

In the event of outcome 1, processing system 700 can perform block 212 by (a) delivering the well-separated matching proposals via synthesized score 134 and (b) returning to block 202 to analyze the next segment of combined feed 101.

The following example can produce outcome 1: The video feed 101A presents a barking dog. Image NN 112A recognizes images of the dog and proposes “dog” with high confidence. Audio NN 122A recognizes barking sounds and proposes “dog” with high confidence. Because the proposals from image NN 112A and audio NN 122A are well-separated and equivalent, synthesized score 134 can propose “dog” with a higher confidence than either of image NN 112A or audio NN 122A alone.

The following example can produce outcome 1: The video feed 101A presents a barking dog. Image NN 112A recognizes images of the dog and proposes “dog” with high confidence. Audio NN 122A recognizes the barking sounds as animal sounds and proposes “animal” with high confidence. Because the proposals from image NN 112A and audio NN 122A are well-separated and consistent (i.e., “animal” is generic to “dog”), synthesized score 134 can propose “dog” with a higher confidence than image NN 112A. The reverse can occur if image NN 112A proposes “animal” and audio NN 122A proposes “dog.”

In the event of outcome 2, processing system 700 can proceed to block 214 (according to some examples) or block 216 (according to other examples). Processing system 700 can be configured to proceed to block 214 when the non-well separated proposals are matching and proceed to block 216 when the non-well separated proposals are non-matching. In the event of outcome 3, processing system 700 can proceed to block 214 (according to some examples) or block 216 (according to other examples).

Processing system 700 can perform block 214 by (a) delivering the proposals via synthesized score 134 (i.e., presenting both proposals) and (b) returning to block 202 to analyze the next segment of combined feed 101. Processing system 700 can perform block 216 by returning to block 202 to analyze the next segment of combined feed 101.

Processing system 700 can decline to produce synthesized score 134 at block 216. Instead, processing system 700 can produce a delay message, indicating that further analysis is required. When relooping due to block 216, processing system 700 can increase processing resources (e.g., computational power) devoted to executing system 100. Once a subsequent loop ends with a block besides 216, processing system 700 can reduce processing resources.

To discourage perpetual looping, processing system 700 can decline to repeat the loop of block 202 to block 216 more than a predetermined number of consecutive times. For example, processing system 700 can decline to repeat the loop more than six times in a row. Thus, after the sixth consecutive instance of block 216, processing system 700 can force outcomes 2 and 3 to block 214.

The following example can produce outcome 2: The video feed 101A is of a distant barking dog in the rain. Due to the distance, image NN 112A proposes “dog” with low confidence. Due to the sound of rain interference with the sound of barking, audio NN proposes “dog” with low confidence. Because the proposals are equivalent (i.e., matching), processing system 700 can proceed to block 214.

The following example can produce outcome 2: The video feed 101A presents a distant barking dog in the rain. Due to the distance, image NN 112A proposes “dog” with low confidence. Due to the sound of rain interfering with the sound of barking, audio NN proposes “animal” with low confidence. Because the proposals are consistent (i.e., matching), processing system 700 can proceed to block 214 and propose “dog” in synthesized score 134.

The following example can produce outcome 2: The video feed 101A presents a barking dog hidden behind a distant parked and silent car. Rain is falling. Due to the distance, image NN 112A proposes “car” with low confidence. Due to the rain, audio NN 122A proposes “dog” with low confidence. “Dog” and “car” are not linked as matching proposals. At block 216, processing system 700 can decline to output a synthesized score 134 and return to block 202 to analyze a new segment of video feed 101A. If the same proposals of “dog” and “car” continue to occur during subsequent loops, processing system 700 can present both “dog” and “car” (i.e., the union of “dog” and “car”) at block 214.

The following example can produce outcome 3: The video feed 101A presents a barking dog hidden behind a parked and silent car. Image NN 112A proposes “car” with high confidence. Audio NN 122A proposes “dog” with high confidence. “Dog” and “car” are not linked as matching proposals. At block 216, processing system 700 can decline to output a synthesized score 134 and return to block 202 to analyze a new segment of video feed 101A. If the same proposals of “dog” and “car” continue to occur during subsequent loops, processing system 700 can present both “dog” and “car” (i.e., the union of “dog” and “car”) at block 214. According to some examples, processing system 700 can proceed directly to block 214 (and thus not loop without issuing a synthesized score 134) because both “dog” and “car” have high confidence (i.e., both are well-separated proposals).

In the event of outcome 4, processing system 700 can produce synthesized score 134 at block 218. This synthesized score 134 can omit the non-well separated proposal by, for example, filling in null values for any objects associated with the non-well separated proposals. During the following discussion, the NN that produced the well-separated proposal is referred to as the source NN and the NN that failed to produce the well-separated proposal is referred to as the subject NN.

At block 220, processing system 700 can examine the subject object set to determine if any objects therein match the source proposal (i.e., the well-separated proposal). The matching can be determined with reference to the score linking map, as discussed above. In particular, the score linking map can provide whether: (a) any objects in the subject object set are identical to the source proposal via a two-way link and (b) any objects in the subject object set are generic to the source proposal via a one-way link. If no matching objects exist in the subject object set, then processing system 700 can skip to block 224.

At block 220, processing system 700 can further determine whether retraining conditions associated with the subject NN are satisfied. For example, image NN 112A can be configured to decline training when the analyzed segment of image feed 111A was captured under low-light conditions. Thus, at block 220, processing system 700 can analyze contrast of the image feed segment to determine whether retraining is appropriate. As another example, audio NN 122A can be configured to decline training when the analyzed segment of audio feed 121A was captured under noisy conditions. Thus, at block 220, processing system 700 can analyze noise level of the audio feed segment to determine whether retraining is appropriate.

At block 222, processing system 700 can retrain the subject NN by issuing first training 132 (e.g., image training 132A) to first NN 112 or second training 133 (e.g., audio training 133A) to second NN 122. During training, (a) the training input can be the segment of first/second feed 111, 121 that produced the subject score (i.e., the analyzed segment), and (b) the desired output can be the matching object in the subject object set.

In this way, the source NN can serve as the source of training data for the subject NN. Retraining algorithms are further discussed below. As discussed above a one-way link can be unidirectional, such that a species (e.g., cat) links to a genus (e.g., animal), but the genus does not link to the species.

After block 222, processing system 700 can return to block 802 via block 224 to perform another loop. During retraining, processing system 700 can enhance processing resources devoted to executing system 100.

The following example can produce outcome 4: The video feed 101A presents a barking dog in the rain. Image NN 112A proposes “dog” with high confidence. Due to distortion from the rain, audio NN 122A proposes “car” with low confidence.

At block 218, processing system 700 can issue a synthesized score 134 proposing “dog” with high confidence. “Dog” and “car” are not linked and thus are not matching. Because the proposal of image NN 112A does not matching the proposal of audio NN 112A, confidence in “dog” of synthesized score 134 can be lower than the confidence of “dog” in image score 113A.

At block 220, processing system 700 can identify the most specific object in the audio object set generic to “dog.” If the audio object set includes “animal,” but not “dog,” then “animal” can be identified. If the audio object set includes “dog,” then “dog” can be identified.

At block 222, processing system 700 can retrain audio NN 122A (retraining is discussed below with reference to FIG. 3). The retraining can cause audio NN 122A to propose “animal” or “dog” (depending on the identified object in the audio object set) in response to future audio feeds of barking distorted by rain.

As previously discussed, processing system 700 can be configured to always train a second NN 122 based on the proposal of first NN 112. A user can set this configuration when the second NN 122 is poorly trained and first NN 112 is well-trained. When in this configuration, processing system 700 can decline to retrain first NN 112 based on any proposal of second NN 122. Alternatively, and instead of always training second NN 122 based on the proposal of first NN 112, processing system 700 can be configured to only train second NN 122 when first NN 112 includes a well-separated proposal (but still never train first NN 112 based on a proposal, even if well-separated, of second NN 122).

Therefore, the following example can produce outcome 4: The video feed 101A presents a barking dog. Image NN 112A proposes “dog” with high confidence. Due to poor training, audio NN 122A proposes “car” with low confidence.

At block 218, processing system 700 can issue a synthesized score 134 proposing “dog” with high confidence. At block 220, processing system 700 can identify the most specific object in the audio object set generic to “dog.” If the audio object set includes “animal,” but not “dog,” then “animal” can be identified. If the audio object set includes “dog,” then “dog” can be identified.

At block 222, processing system 700 can retrain audio NN 122A (retraining is discussed below with reference to FIG. 3). The retraining can cause audio NN 122A to propose “animal” or “dog” (depending on the identified object in the audio object set) in response to future audio feeds of barking.

### Part 5

FIG. 3 depicts a deep NN 300, which can be illustrative of one or both of first NN 112 and second NN 122. Deep NN 300 can include an input layer 301, a plurality of hidden layers 302, 303, and an output layer 304. Each layer 301-304 can include a plurality of nodes 301a-304a. Although not shown in FIG. 3, each layer 301-304 can include a plurality of node levels. As such, each layer 301-304 can be one dimensional, two dimensional, three dimensional, etc.

Although only two hidden layers 302, 303 are illustrated, deep NN can include more hidden layers (e.g., three, four, ten, etc., or more). Since each NN 112, 122 can be software running on a general purpose computer, nodes 301a-304a, can exist as code (e.g., software objects).

Each node 301a-304a can be connected to one or more nodes in another layer. When two nodes are connected, an output of an upstream node can serve as an input to the downstream node. Nodes in one layer can be simultaneously connected to the same nodes in another layer. Put differently, the output of a single upstream node can serve as an input for multiple downstream nodes. Each node 301a-304a can be a neuron 350 (see FIG. 3A).

Input nodes 301a can be configured to accept an input feed such as first feed 111 and second feed 112. Input nodes 301a, unlike the downstream nodes 302a-304a, are not necessarily neurons 350. Input nodes 301a can be configured to accept incoming information according to a predetermined and constant formula that is immune to training. Processing system 700 can turn off clusters of input nodes 301a to crop (also called localize) a data segment.

As stated above, image feed 111A can be a series of images (e.g., frames). Image NN 112A, via input layer 301, can accept discrete segments of image feed 111A. According to some examples, each segment is a single image (e.g., frame) of image feed 111A and each image score 113A classifies a single video frame. According to these examples, each first node 301a of image NN 112 can accept the color value (e.g., either red, green, or blue) of a specified pixel (e.g., the top left pixel of the image). When image NN 112A is convolutional, input layer can have three levels, where each level accepts a different color value.

Audio feed 121A can begin as a waveform (e.g., an analog waveform, a digital representation of an analog waveform). Prior to reaching audio NN 122A (e.g., at splitter 102), audio feed 121 can be transformed into a spectrogram with a time dimension, a frequency dimension, and an amplitude dimension. The transformation can involve one or more Fourier transforms of the audio waveform. According to this example, each first node 301a of audio NN 122A can accept the amplitude of a specified frequency (e.g., a specified frequency range).

Second, third, and fourth nodes 302a-304a can be neurons 350. Referring to FIG. 3A, neuron 350 can receive an input matrix I, which can include inputs [I₁, I₂, . . . I_{N}]. Neuron 350 can take the dot product of input matrix I with respect to a weight matrix W, which can include weights [W₁, W₂. . . W_{N}]. Neuron 350 can add a bias to the dot product, then apply an activation function 361 to the sum.

The bias can be a negative number and thus prevent activation function 361 from firing neuron 350 when the inputs produce a small effect. In this way, the biases can suppress neurons 350 that would otherwise produce a small output 371 in favor of neurons 350 that produce a large output 371.

The result of the activation function can be neuron output 371. Neuron output 371 can be produced with the following equation: Neuron Output 371=AF(b+Σₖ₌₀^{N}Iₖ·Wₖ). “AF” stands for activation function 361 and “b” stands for bias 362.

Activation function 361 can be any suitable activation function such as a sigmoid function, a hyperbolic tangent function, a rectified linear (also called ReLU) function, a softplus function, a softmax function, and the like. A sigmoid function can have the form:

$$f ( x ) = \frac{1}{1 + {e}^{- x}} .$$

A hyperbolic tangent function can have the form: f(x)=tanh(x). A rectified linear function can have the form: f(x)=max(0, x). A softplus function can have the form: f(x)=ln(1+e^{x}) . In the preceding equations, “x” can have the form: x=(b+Σₖ₌₀^{N}Iₖ·Wₖ). An example form of a softmax function is discussed below.

Returning to FIG. 3, and when deep NN 300 is feedforward, the inputs I to each neuron 350 can be the outputs of any number of nodes in an upstream layer. For example, each node 302a in first hidden layer 302 can accept, as an input, the output of each node 301a in input layer 301. This arrangement is only exemplary. Alternatively, each node 302a in first hidden layer 302 can accept, as an input, the output of a predetermined small group of nodes 301a in input layer 301.

According to some examples, deep NN 300 is a feedforward convolutional NN where at least some of the hidden layers are convolutional layers. In such a NN, each first hidden layer node 302a can have a local receptive field, such that each first hidden layer node 302a connects to a small cluster of input layer nodes 301a.

To simplify training, each node of a convolutional layer level can have the same weights, the same activation function, and the same bias. Some of the hidden layers can be pooling (also called downsampling) layers. Output layer 304 can be a fully connected layer, where each output layer node 304a connects to each node in an upstream layer (e.g., each second hidden layer node 303a).

Output layer nodes 304a can have a softmax activation function. One kind of softmax activation function (called a sigmoid softmax activation function) can have the form:

$$f ( x ) = \frac{{e}^{x}}{{\sum }_{k} {e}_{k}^{x}} .$$

Here, “k” can represent the number of output layer nodes and “x” can have the form: x=(b+Σₖ₌₀^{N}Iₖ·Wₖ).

As a result, the sum of all nodes in a particular level of a fully connected softmax output layer can be one and the output of each output layer node 304a can be the probability of (e.g., confidence in) one entry in the object set. The output of each output layer node 304a can be listed in a score (e.g., a single confidence matrix).

Deep NN 300 can be feedforward or recurrent. If recurrent, the output of each neuron 350 may fire for a time duration determined by activation function 361. In a recurrent deep NN 300, outputs of neurons 350 in a downstream layer can loop backward to input toward neurons 350 in an upstream layer.

Deep NN 300 can perform supervised training. During supervised training, deep NN 300 can be presented with a set of training inputs and a corresponding set of training outputs. Deep NN 300 can accept the training inputs, and generate outputs. Deep NN 300 can compare the generated outputs to the set of training outputs. The training outputs represent desired (e.g., correct) outputs.

During training, deep NN 300 can automatically adjust the biases and the weights based on differences between the generated outputs and the training outputs. A cost function (discussed below) can be applied to quantify the comparison between generated outputs and training (e.g., desired) outputs.

Deep NN 300 can perform supervised training with any suitable technique, such as backpropagation via stochastic gradient descent (e.g., the Hessian technique, momentum-based gradient descent, conjugate gradient descent). Backpropagation via stochastic gradient descent can include taking partial derivatives of the cost function with respect to some or all of the weights and biases in deep NN 300, then applying the partial derivatives to minimize the cost function.

The cost function (“CF”) can be a quadratic cost function, a cross-entropy cost function, and the like. When quadratic, the cost function can have a form:

$$CF ( w , b ) = \frac{1}{2 n} * {\sum }_{z} {( y ( z ) - o )}^{2} .$$

According to this equation “n” is the total number of training inputs, y(z) is the desired output of each training input, and “o” is the observed output (i.e., the output at output layer 304), of each training input.

As stated above, a partial derivative of cost function CF can be found with respect to each weight and bias in deep NN 300. A collection of these partial derivatives is the gradient of cost function CF. Since deep NN 300 can be nonlinear, the partial derivatives can be approximated by slightly adjusting a weight or bias and finding the corresponding change in cost function

$$CF \text{:} \frac{\partial CF}{\partial p} \approx Δ CF / Δ p .$$

Here, “p” represents any weight “w” or bias “b”. To accelerate computation, the partial derivatives can be found with a random subsample of training inputs.

Once each partial derivative has been estimated, each weight w and bias b can be adjusted to reduce cost C. Adjustment of weights is called reweighting and adjustment of biases is called rebiasing. After each iteration of adjusting weights w and biases b, the partial derivatives can be re-estimated for the next iteration. Ideally, cost C is reduced to zero. In practice, cost C can be minimized to some positive value.

Returning to FIG. 1, first NN 112 can be trained such that first score 113 is a classification matrix of first feed 111. Second NN 122 can be trained such that second score 123 is a classification matrix of second feed 122. Each of first NN 112 and second NN 122 can have the same number of fully connected output layer nodes 304a.

Each output layer node 304a can correspond to one object in an object set. Score control 131 can assign a single object (e.g., dog) to one output layer node 304a of first NN 112 and to one output layer node 304a of second NN 122. First NN 112 and second NN 122 can thus be configured to generate classification matrices listing classification probabilities of identical object sets.

For example, image score 113A can be in the form of [probability of image feed 111A showing a dog, probability of image feed 111A showing a cat, probability of image feed 111A showing a horse]. Audio score 123A can have the same form: [probability of audio feed 121A including sounds from a dog, probability of audio feed 121A including sounds from a cat, probability of audio feed 121A including sounds from a horse].

### Part 6

As discussed above, first and second NNs 112, 122 can respectively analyze discrete segments of first and second feeds 111, 121. Two example segmenting techniques are discussed below. Processing system 700 can be configured to perform either or both techniques.

Technique 1 can be applied for non-time sensitive scoring (e.g., a local government wants to determine the number of different people who use a certain sidewalk each day). Technique 2 can be applied for time sensitive classification, where the latest information is the most relevant (e.g., an autonomous vehicle is controlled based on processing system 700).

According to both techniques, the analyzed segment of first feed 111 can time-intersect the analyzed segment of second feed 121. Thus, if first and second feeds 111, 121 are not time-synchronized, processing system 700 can analyze metadata of first and second feeds 111, 121 to ensure that time-intersecting (e.g., synchronized) segments of first and second feeds 111, 121 are feed into first and second NNs 112, 122.

Technique 1: Image NN 112A can accept and individually process every frame of image feed 111A. To conserve processing power, image NN 112A can skip frames (e.g., only process one of every five frames). Audio NN 122A can accept audio feed 121 buffering the frame analyzed by image NN 112A.

For example, image feed 111A can include N frames per second and image NN 112A can analyze M/N frames. When M=N, then image NN 112A analyzes every incoming frame. When M<N, then image NN 112A analyzes only a portion of incoming frames. According to this example, audio NN 122A can analyze waveform (e.g., in spectrogram form) of a block of audio in the time range [T−M/(2N), T+M/(2N)], where T is a time corresponding to the frame being analyzed by image NN 112.

For example, if image feed 111A included 25 frames per second and image NN 112A analyzed 3/25 frames, then audio NN 122A could be set to analyze audio feed 121A in the time range [T− 3/50, T+ 3/50]. If the current frame analyzed by image NN 112A played at T=30 seconds into multimedia feed 101A, then the time range could be centered about 30 seconds to yield [30− 3/50, 30+ 3/50].

Referring to FIG. 2, system 100 can perform block 202 in parallel with blocks 204-224. Thus, system 100 can continuously receive and save combined feed 101. When the operations return to perform a new loop, processing system 700 can split the next segment of combined feed 101.

Technique 2: Alternatively, image NN 112A can be configured to accept a most recent segment of incoming feed. When a new loop of the operations of FIG. 2 occurs, image NN 112A can accept the first frame delivered by splitter 102A. As stated above, each frame can be associated with a time T. Audio NN 122A can then accept a block of waveform in a time range TR that includes (i.e., instersects) time T (e.g., TR=[T, T+X], where X is a predetermined time constant).

According to technique 2, block 202 can be performed sequentially in the operations of FIG. 2. When block 202 occurs, processing system 700 accepts a new segment of feed (e.g., [T, T+X]), where T is the time when processing system 700 begins executing block 202 and X is a predetermined time constant. Processing system 700 then splits the new segment of feed to deliver a single frame of the new segment (corresponding to time T) to image NN 112A and to deliver waveform from the new segment (corresponding to timeframe [T, T+X]) to audio NN 122A.

Because processing system 700 can select the appropriate frame prior to selecting the appropriate waveform, processing system 700 can begin executing image NN 112A prior to executing audio NN 122A. Instead of delivering the first split frame (corresponding to time T) to image NN 112A, processing system 700 can deliver a frame corresponding to the middle of the segment [T, T+X]. In this case, image NN 112A would analyze a frame corresponding to time T+(X/2). According to this example, image NN 112A could still begin processing prior to audio NN 122A.

### Part 7

To enhance consistency of first and second scores 113, 123, processing system 700 can perform source localization. Source localization can, for example, focus a NN on a relevant portion of incoming data. The remainder of the incoming data can be cropped.

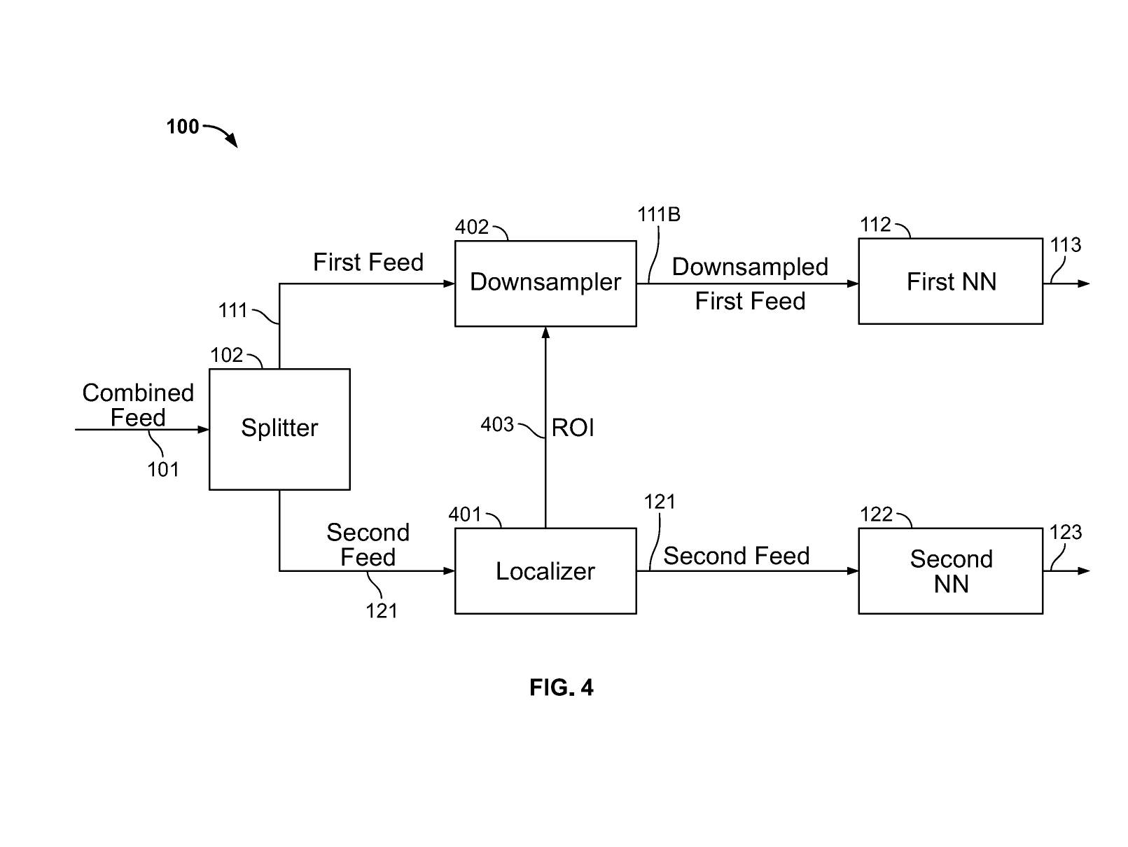

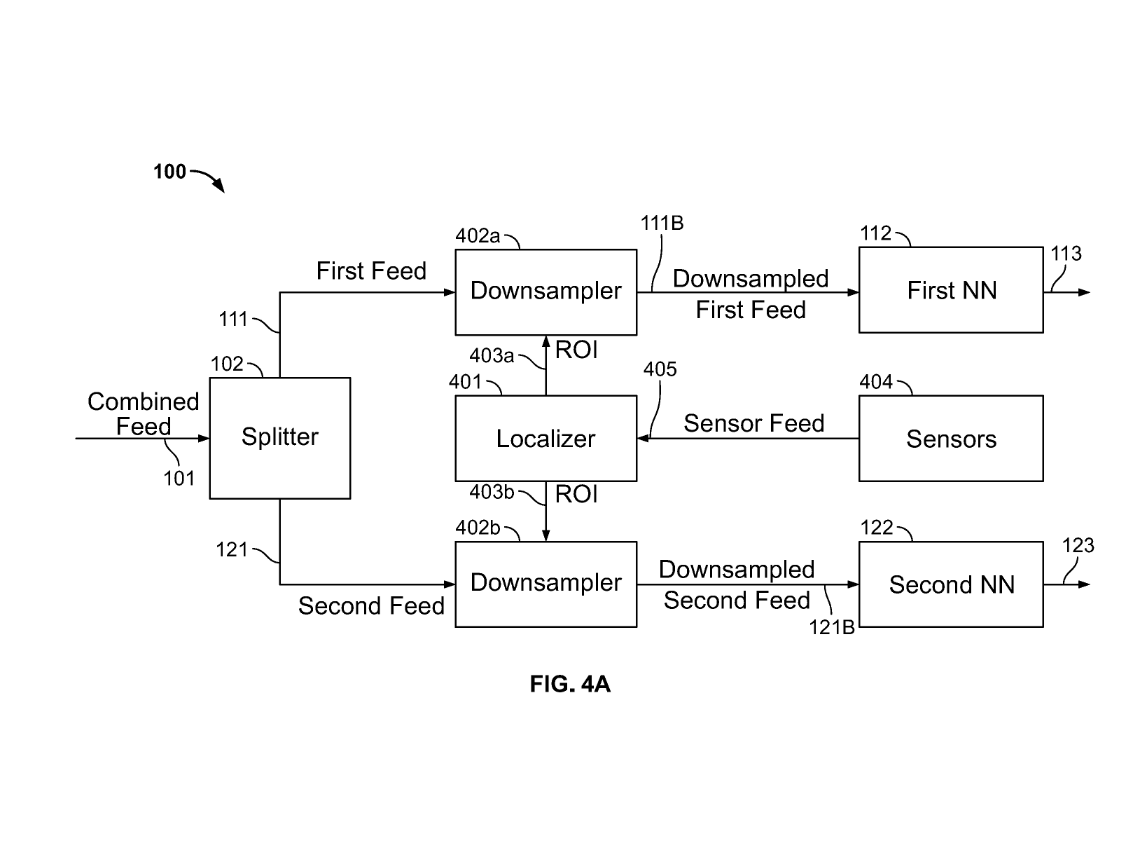

Referring to FIG. 4, system 100 can include a localizer 401 downstream of splitter 102 and a cropper 402 downstream of both splitter 102 and localizer 402. For convenience, FIG. 4 shows cropping of first feed 111 based on data contained in second feed 121. This is only an example. The roles of first feed 111 and second feed 121 can be swapped. The blocks shown in FIG. 4 can represent discrete hardware components or can represent code executed by one or more processors.

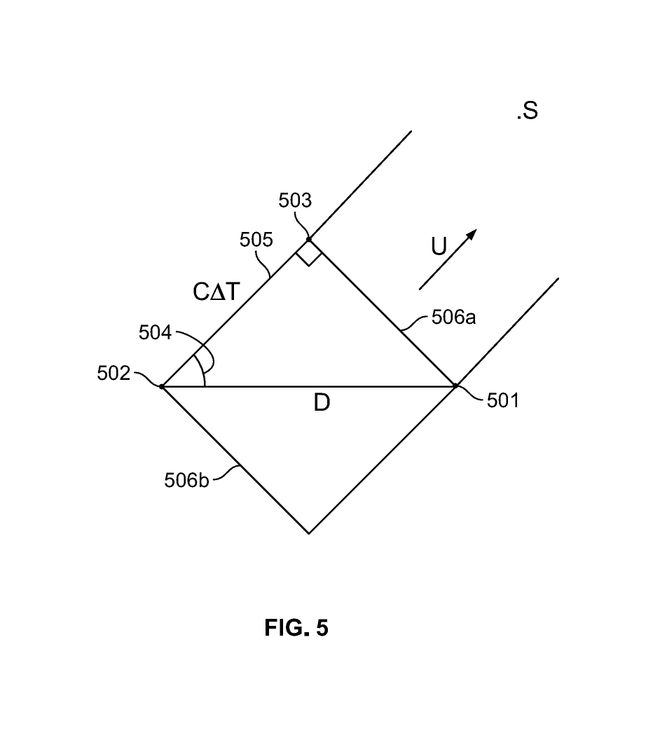

As shown in FIG. 4, second feed 121 (e.g., audio feed 121A) reaches localizer 401, which identifies a region of interest (“ROI”) 403. ROI 403 can be a spatial area, a group of frequencies, or any other piece of information that identifies desirable data in first feed 111. FIG. 5 (discussed below) shows an example method of identifying ROI 403.

Cropper 402 accepts first feed 111 and ROI 403. Cropper applies ROI 403 to crop first feed 111. If first feed 111 is image feed 111A, then the cropping can include removing all pixels from image feed 111A outside of ROI 403. As discussed below, cropper 402 can represent one or more layers of first NN 112. For example, cropper 402 can be input layer 301 of first NN 112 and cropping can be performed by selectively deactivating input layer nodes 301a corresponding to an undesired portion of first feed 111.

Cropper 402 transmits cropped first feed 111B to first NN 112, which produces first score 113. Localizer 401 transmits the original second feed 121 to second NN 112, which produces second score 123. The first and second scores 113, 123 arrive at score control 131, which operates as discussed above.

FIG. 4A depicts another example of source localization. In FIG. 4A, both first and second feeds 111, 121 can be cropped according to sensor feed 405 produced by sensors 404. For example, first feed 111 can be frames from a wide field-of-view camera, second feed 121 can be frames from a zoomed field-of-view camera, sensors 404 can be microphones, and sensor feed 405 can be an audio stream.

Localizer 401 produces two ROIs 403a and 403b based on sensor feed 405. First cropper 402a converts first feed 111 into cropped first feed 111B based on first ROI 403a. Cropped first feed 111B proceeds to first NN 112. Second cropper 402b converts second feed 121 into cropped second feed 121B based on second ROI 403b. Cropped second feed 121B proceeds to second NN 122.

In both FIG. 4 and FIG. 4A, a NN accepts feed after passing through a cropper 402. Cropper 402 can represent hardware/software that operates on feed prior to reaching a NN. Cropper 402 can represent a portion of a NN.

Referring to FIG. 4A, and as previously discussed, cropper 402 can represent input layer 301 of first NN 112. Processing system 700 can adjust input nodes 301a based on ROI 403. For example, input nodes 301a mapping to ROI 403 can perform normally, while input nodes 301a not mapping to ROI 403 can be adjusted (e.g., deactivated to return zeros). The same concepts apply to system 100 of FIG. 4.

According to some examples, localizer 401 operates on a downsampled feed, while each NN operates on a non-downsampled feed. Referring to FIG. 4, processing system 700 can downsample second feed 121 (e.g., via splitter 102) and input the downsampled second feed to localizer 401. Second NN 122 can either accept downsampled second feed 121 or non-downsampled second feed 121. The same concepts apply to FIG. 4A (e.g., sensor feed 405 can be a downsampled sensor feed).

FIG. 5 illustrates a technique for identifying ROI 403. In FIG. 5, first microphone 501 and second microphone 502 are a known distance D apart. Source S is generating sound. Segment 506a represents the sound's wavefront at time T₁. Segment 506b represents the sound's wavefront at time T₂. Segment 505 extends from second microphone 502 to perpendicularly intersect wavefront 506a.

Processing system 700 can apply this information to find a unit vector u pointing in the direction of source S. Processing system 700 can approximate a length of segment 505 as: c*ΔT, where “c” is the speed of sound and ΔT is T₁−T₂. Once the length of segment 505 is known, the length of segment 506a can be found via the Pythagorean theorem and angle 504 can be found via an inverse cosine of segment 505 and distance D. Unit vector u can be set to extend from the middle of segment 506a at angle 504.

Processing system 700 can generate a depth map of image feed 111A and map the known locations of microphones 501, 502 with respect to the depth map. Processing system 700 can set ROI 403 as extending from segment 506a in the direction of unit vector u. Processing system 700 can downsample image feed 111A to remove pixels falling outside of ROI 403 using the above-described techniques.

### Part 8

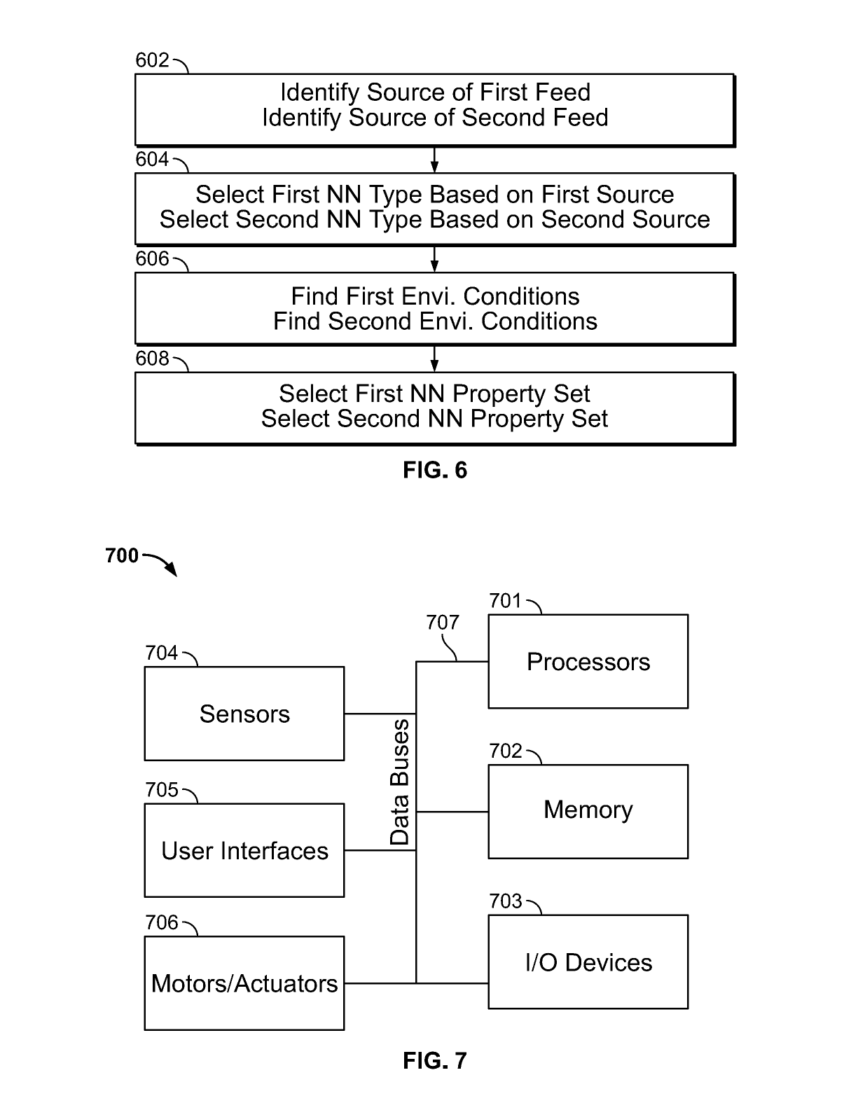

Referring to FIGS. 1, 2, and 6 processing system 700 can be configured to select a first NN species and a second NN species by performing the operations of blocks 602-608. With reference to FIG. 2, processing system 700 can perform blocks 602-608 after block 204 and before blocks 206 and 208.

Each species can be defined by a NN type and a NN property set. Processing system 700 can store a pool of NN types and a pool of NN property sets for each NN type.

Each NN type can correspond to a type of sensor responsible for originating feed entering the NN. Thus, at block 602, processing system 700 can read metadata in combined feed 101 and/or metadata in first feed 111 and second feed 121. This metadata can identify the sensor responsible for capturing the feed. At block 604, processing system 700 can select from a pool of NN types based on the metadata.

The following are example NN types: a camera with a wide-angle field of view can feed to NN type A; a camera with a zoomed field of view can feed to NN type B; a LiDAR sensor can feed to NN type C; an ultrasonic sensor can feed to NN type D; a microphone can feed to NN type E. First NN 112 can be any of these types. Second NN 122 can be any of these types.

For example, when metadata in combined feed 101 and/or first feed 111 identifies that a wide-angle field of view sensor captured first feed 111, then processing system 700 can select NN type A for first NN 112. When metadata in combined feed 101 and/or second feed 121 identifies that a zoomed field of view sensor captured second feed 121, then processing system 700 can select NN type B for second NN 122.

At block 606, processing system 700 can find first and second environmental conditions. Examples of environmental conditions include temperature, humidity, time of day, amount of precipitation, kind of precipitation, amount of light, speed, acceleration, location, and the like.

The first environmental conditions can relate to the environment in which first feed 111 was captured and the second environmental conditions can relate to the environment in which second feed 121 was captured. The environmental conditions of the sensor capturing first feed 111 can be appended as metadata to first feed 111. The same applies to second feed 121. Alternatively, processing system 700 can receive environmental conditions through an independent channel.

At block 608, processing system 700 can select a NN property set for first NN 112 based on the environmental conditions present when first feed 111 was captured. For example, if the segment of first feed 111 to be analyzed is a frame captured at time T, then processing system 700 considers environmental conditions present at time T. The same applies to second NN 122 and second feed 121.

Each NN property set can be associated with a particular NN type. For example, property sets 1-20 can be associated with NN type A, property sets 21-40 can be associated with NN type B, and so on.

Each property set can govern the configuration of a NN. For example, property set 1 may have a first set of layers, a first set of levels, a first set of node connections, a first set of weights, a first set of activation functions, one or more first cost functions, and a first object set. Property set 2 can have a second set of layers, a second set of levels, a second set of connections, a second set of weights, a second set of activation functions, one or more second cost functions, and a second object set. The first properties can be the same or different than the second properties (e.g., the first object set can be the same as the second object set, but the first set of weights can be different than the second set of weights). One property set can cause the selected NN type to return no score.

Property sets can further govern retraining conditions. For example, one property set for an image-type NN 112A can decline to accept training when the analyzed segment of image feed 111A was captured under low-light conditions. Processing system 700 can determine that a segment of image feed 111A was captured under low-light conditions by analyzing the contrast of the image feed segment.

The following chart illustrates an example selection algorithm for first NN 112. As shown in the chart, the property set for the selected NN type can depend on both speed and light. The selection algorithm can be made three-dimensional by including location as a further selection criteria. The selection algorithm can be made four-dimensional by including humidity as a further selection criteria and so on. The selection strategy for each NN type can be different.

Speed

| | | |
|---|---|---|
| First NN property set selection | high | low |

| | | | |
|---|---|---|---|
| Light | high | A | B |
| | low | C | D |

Retraining during block 222 can be directed to the NN species that produced the incorrect score. For example, if first NN 112 has species [type B, property set 5], then only type B, property set 5 can be subject to retraining. NN type B, property sets 1-4 can remain static.

### Part 9

Referring to FIG. 7, processing system 700 can include one or more processors 701, memory 702, one or more input/output devices 703, one or more sensors 704, one or more user interfaces 705, one or more motors/actuators 706, and one data buses 707.

Processors 701 can include one or more distinct processors, each having one or more cores. Each of the distinct processors can have the same or different structure. Processors 701 can include one or more central processing units (CPUs), one or more graphics processing units (GPUs), application specific integrated circuits (ASICs), digital signal processors (DSPs), and the like.

Processors 701 are configured to perform a certain function or operation at least when one of the one or more of the distinct processors is capable of executing code, stored on memory 702 embodying the function or operation. Processors 701 can be configured to perform any function, method, and operation disclosed herein.

Memory 702 can include volatile memory, non-volatile memory, and any other medium capable of storing data. Each of the volatile memory, non-volatile memory, and any other type of memory can include multiple different memory devices, located at a multiple distinct locations and each having a different structure.

Examples of memory 702 include a non-transitory computer-readable media such as RAM, ROM, flash memory, EEPROM, any kind of optical storage disk such as a DVD, a Blu-Ray® disc, magnetic storage, holographic storage, an HDD, an SSD, any medium that can be used to store program code in the form of instructions or data structures, and the like. The methods, functions, and operations described in the present application can be fully or partially embodied in the form of tangible and/or non-transitory machine readable code saved in memory 702.

Input-output devices 703 can include any component for trafficking data such as ports and telematics. Input-output devices 703 can enable wired communication via USB®, DisplayPort®, HDMI®, Ethernet, and the like. Input-output devices 703 can enable electronic, optical, magnetic, and holographic, communication with suitable memory 703. Input-output devices can enable wireless communication via WiFi®, Bluetooth®, cellular (e.g., LTE®, CDMA®, GSM®, WiMax®, NFC®)), GPS, and the like.

Sensors 704 can capture physical measurements of environment and report the same to processors 701. Sensors 704 can include LIDAR sensors, image sensors, temperature sensors, acceleration sensors, ultrasonic sensors, microphones, voltage sensors, motion sensors, light sensors, capacitance sensors, current sensors, and the like. Sensors 704 can comprise a video camera configured to deliver multimedia feed 101A. Sensors 704 can include any sensors discussed herein.

User interface 705 enables user interaction with imaging system 100. User interface 705 can include displays (e.g., OLED touchscreens, LED touchscreens), physical buttons, speakers, microphones, keyboards, and the like.

Motors/actuators 706 enable processor 301 to control mechanical or chemical forces. Motors/actuators 706 can include a vehicle motor and vehicle steering. According to one example, processing system 700 controls vehicle motor and/or steering based on synthesized score 134.

Data bus 707 can traffic data between the components of processing system 700. Data bus 707 can include conductive paths printed on, or otherwise applied to, a substrate (e.g., conductive paths on a logic board), SATA cables, coaxial cables, USB® cables, Ethernet cables, copper wires, and the like. Data bus 707 can be conductive paths of a logic board to which processor 301 and the volatile memory are mounted. Data bus 707 can include a wireless communication pathway. Data bus 707 can include a series of different wires 707 (e.g., USB® cables) through which different components of processing system 700 are connected.

We claim:

1. A neural network processing system comprising one or more processors configured to:
execute a first neural network;
execute a second neural network;
run a first data segment through the first neural network to return a first score;
run a second data segment through the second neural network to return a second score;
compare the first score with the second score; and
retrain the first neural network based on the comparison.

2. The system of claim 1, wherein during execution, the first neural network comprises a neuron configured to apply a weight to an input; and
the one or more processors are configured to adjust the weight during retraining.

3. The system of claim 2, where the one or more processors are configured to retrain the first neural network based on the second score.

4. The system of claim 1, wherein the one or more processors are configured to:
when comparing the first score with the second score:
extract a first proposal from the first score and extract a second proposal from the second score; and
determine whether the first and second proposals match;
retrain the first neural network based on determining that the first and second proposals fail to match.

5. The system of claim 4, wherein the one or more processors are configured to, when retraining the first neural network based on the comparison:
reweight and/or rebias the first neural network such that the first data segment, when run through the first neural network, produces the second proposal.

6. The system of claim 4, wherein the one or more processors are configured to:
(a) when comparing the first score with the second score:
determine whether the first proposal is well-separated;
determine whether the second proposal is well-separated;
(b) retrain the first neural network based on determining that (i) the first and second proposals fail to match, (ii) the first proposal is not well-separated, and (iii) the second proposal is well-separated.

7. The system of claim 1, wherein the one or more processors are configured to:
accept a combined feed; and
split the combined feed into the first data segment and the second data segment, such that the first and second data segments have different modalities.

8. The system of claim 1, wherein the first data segment is an image feed segment, the second data segment is an audio feed segment, the first neural network, upon execution, is configured to classify the image feed segment, and the second neural network, upon execution, is configured to classify the audio feed segment.

9. The system of claim 8, wherein the one or more processors are configured to:
accept a combined feed; and
split the combined feed into the image feed segment and the audio feed segment.

10. The system of claim 1, wherein the one or more processors are configured to retrain the second neural network based on the comparison.

11. A method of processing data with a neural network, the method comprising:
executing a first neural network;
returning a first score by running a first data segment through the first neural network;
executing a second neural network;
returning a second score by running a second data segment through the second neural network;
comparing the first score with the second score;
determining whether to retrain the first neural network based on the comparison;
determining whether to retrain the second neural network based on the comparison; and
retraining the first neural network based on the second score or retraining the second neural network based on the first score.

12. The method of claim 11, further comprising:
splitting a multimedia feed into an image feed and an audio feed, the image feed comprising the first data segment, the audio feed comprising the second data segment.

13. The method off claim 11, further comprising:
selecting the first neural network from a plurality of neural network species based on the first data segment; and
selecting the second neural network from a plurality of neural network species based on the second data segment.

14. The method of claim 13, further comprising:
identifying an environmental condition concurrent with a capture time of the first data segment; and
selecting the first neural network from the plurality of neural network species based on the environmental condition.

15. The method of claim 11, wherein the second neural network, upon execution, comprises a plurality of hidden layers; and
the method further comprises:
cropping the first data segment prior to running the first data segment through the plurality of hidden layers.

16. The method of claim 15, further comprising cropping the first data segment based on the second data segment.

17. A neural network processing system comprising one or more processors configured to execute the method of claim 15.

18. A neural network processing system comprising:
means for producing a first score from a first data segment with a first neural network;
means for producing a second score from a second data segment with a second neural network;
means for comparing the first score with the second score; and
means for retraining the first neural network based on the second score.

19. The neural network processing system of claim 18, wherein the means for comparing the first score with the second score comprise:
means for extracting a first proposal from the first score;
means for determining whether the first proposal is well-separated;
means for extracting a second proposal from the second score; and
means for determining whether the second proposal is well-separated.

20. A non-transitory, computer-readable storage medium comprising program code, which, when executed by one or more processors, causes the one or more processors to:
extract a first data segment from a first feed;
extract a second data segment from a second feed;
analyze the second data segment;
crop the first data segment based on the analysis;
execute a first neural network and a second neural network;
run the cropped first data segment through the first neural network to produce a first score; and
run the second data segment through the second neural network to produce a second score.

21. The storage medium of claim 20, wherein the program code causes the one or more processors to retrain the second neural network based on the first score.

22. The storage medium of claim 20, wherein the program code causes the first neural network, upon execution, to comprise an input layer with a plurality of input nodes and at least one hidden layer; and
the program code causes the one or more processors to crop the first data segment by deactivating some of the input nodes.
